(19) United States
(12) Patent Application Publication
(10) Pub. No.: US 2025/0108506 A1
(43) Pub. Date: Apr. 3, 2025

(54) SYSTEMS AND METHODS TO ESTIMATE FORCE OF AN INSTRUMENT

(71) Applicant: CASE WESTERN RESERVE UNIVERSITY, Cleveland, OH (US)

(72) Inventors: Zonghe Chua, Cleveland, OH (US); My Hoang Ha Le, Cleveland, OH (US); Kyle Golobish, Cleveland, OH (US); Shuyuan Yang, Cleveland, OH (US)

(21) Appl. No.: 18/901,645

(22) Filed: Sep. 30, 2024

Related U.S. Application Data
(60) Provisional application No. 63/586,563, filed on Sep. 29, 2023.

(51) Int. Cl. B25J 9/16; B25J 11/00; B25J 13/08

(52) U.S. Cl. CPC B25J 9/1653; B25J 9/163; B25J 11/00; B25J 13/089

(57) ABSTRACT

An example method includes estimating, by a processor, a spatial position of a portion of an instrument that is adapted to interact with an environmental structure to provide an estimated spatial position for the instrument, in which the spatial position is estimated based on image data that includes at least one image frame of the portion of the instrument and the environmental structure. The method also includes responsive to detecting contact between the instrument and the environmental structure, estimating, by the processor, a measure of force between the instrument and the environmental structure based on the estimated spatial position for the instrument.

### RELATED APPLICATION

This application claims priority from U.S. Provisional Application No. 63/586,563, filed Sep. 29, 2023, the subject matter of which is incorporated herein by reference in its entirety.

### TECHNICAL FIELD

This description relates to systems and methods for force estimation, such as a contact-conditional force estimate.

### BACKGROUND

In various applications involving remote control of instruments, there is a need for a user to receive feedback related to the use of the instrument and its interaction with the environment. For example, in telesurgery applications, such as for performing minimally invasive or other surgical procedures, haptic feedback can be helpful to assist the user to control forces being applied by a robotically controlled surgical instrument. Existing approaches to provide this and other forms of feedback tend to be complicated and/or are limited when adapting to various environments.

### SUMMARY

This description relates to systems and methods for force estimation, such as a contact-conditional force estimate.

A described example method includes estimating, by a processor, a spatial position of a portion of an instrument that is adapted to interact with an environmental structure to provide an estimated spatial position for the instrument, in which the spatial position is estimated based on image data that includes at least one image frame of the portion of the instrument and the environmental structure. The method also includes responsive to detecting contact between the instrument and the environmental structure, estimating, by the processor, a measure of force between the instrument and the environmental structure based on the estimated spatial position for the instrument.

Another described example relates to a system that includes one or more processors and one or more non-transitory machine-readable media storing data and executable instructions. The data includes image data that includes at least one image frame of a portion of an instrument and an environmental structure with which the instrument is adapted to interact. The instructions, when executed by the processor, cause the processor to perform a method that includes classifying a contact condition between the portion of the instrument and the environmental structure based on the at least one image frame. The method also includes estimating a spatial position or displacement of the portion of the instrument to provide an estimated spatial position or displacement for the instrument, in which the estimated spatial position or displacement for the instrument is based on the image data. The method also includes responsive to the classified contact condition between the instrument and the environmental structure, estimating a measure of force between the instrument and the environmental structure based on the estimated spatial position or displacement for the instrument.

Another described example relates to a system that includes an imaging device and a computing apparatus. The imaging device is configured to provide image data including a plurality of image frames, in which the image frames include a remotely control instrument and a deformable structure. The computing apparatus includes instructions stored in non-transitory memory, which are executable by a processor. The instructions include a contact detection model that classifies a contact condition between a portion of the instrument and the deformable structure based on at least one image frame. The instructions also include a keypoint identification model that generates keypoints data based on the at least one image frame, in which the keypoints data defines a geometric network of keypoints of the instrument and includes coordinates of pixels or voxels in the at least one image frame. The instructions also include a position estimation model that generates a predicted position estimate representative of a spatial position or displacement of the portion of the instrument to, in which the estimated spatial position or displacement for the instrument is based on the keypoints data. The instructions also include a force estimation model that generates a predicted force estimate responsive to the classified contact condition between the instrument and the deformable structure, the predicted measure of force between the instrument and the environmental structure being determined by the force estimation model based on the predicted position estimate.

### BRIEF DESCRIPTION OF DRAWINGS

FIG. 1 illustrates an example of labelled feature points overlayed on multiple camera views of an instrument.

FIG. 2A illustrates an example of graph connectivity based on labeled feature points from images.

FIG. 2B illustrates an example of inputs, layer arrangement and output of an example graph neural network position estimator.

FIGS. 3A-3D illustrates examples of images from an artificial silicone tissue dataset of a portion of an instrument in various states of contact for multiple configurations.

FIGS. 4A-4B illustrates example images from a clinical-like dataset with a static anatomical background image.

FIG. 5A illustrates predicted contact probabilities for a contact model using an EfficientNetB3 backbone.

FIG. 5B illustrates an example small convolutional neural network (CNN) contact detection model.

FIG. 6. illustrates an example of normalized end-effector position predictions implemented by position estimators compared to joint encoder-based position.

FIG. 7 illustrates an example of a stiffness model fit to material being manipulated with contact conditional displacement readings from joint encoders.

FIGS. 8A-8B illustrate example force predictions for force estimation approaches that include robot state and no robot state information.

FIG. 9A illustrates predicted contact probabilities on one demonstration from models trained using ground truth contact labels from force sensor measurements, and FIG. 9B illustrates predicted contact probabilities on one demonstration from models trained using human contact labels.

FIG. 10 illustrates examples of scaled position predictions using the GNN and FCN compared to a joint encoder-based position estimated of the instrument on a realistic dataset.

FIG. 11A illustrates example force predictions for force estimation approaches that include robot state and FIG. 11B illustrates example force predictions for force estimation approaches that include no robot state information.

FIG. 12 illustrates a box plot showing the accuracy of contact predictions using the EfficientNet-based visual contact detector trained on different numbers of human-labeled examples from the realistic dataset.

FIG. 13A illustrates example box plots showing RMSE of normalized position estimates for models trained on different amounts of human-labeled examples from the realistic dataset with pre-training on silicone dataset, and FIG. 13B illustrates example box plots showing RMSE of normalized position estimates for models trained on different amounts of human-labeled examples from the realistic dataset without pre-training.

FIG. 14 depicts an example system for estimating force of an instrument with respect to an environmental structure.

FIG. 15 is a flow diagram depicting an example method for estimating force of an instrument with respect to an environmental structure.

### DETAILED DESCRIPTION OF THE INVENTION

This description relates to systems and methods for force estimation, such as a contact-conditional force estimate.

As an example, image data can be acquired by one or more imaging devices (e.g., cameras) such as showing a remotely control instrument and an environmental structure. In some examples described herein, the systems and methods relate to a robotically controlled instrument interacting with a deformable structure (e.g., tissue) such as in telesurgical context (e.g., a medical environment). In such examples, the force estimate can describe a force between the instrument and the deformable structure (e.g., the tissue), such as an estimate of an applied force. However, the systems and methods are applicable to estimate force in other contexts and environments, such as industrial applications, space or underwater environments, and the like where an instrument (e.g., tool) can interact with one or more objects.

Contact-Conditional Local Force and Stiffness Estimation with Known Robot State Information

In some examples, the robot state is accessible, such as in a research robot like the da Vinci Research Kit (dVRK). While examples here refer to the dVRK, it is to be understood that such reference can be interpreted more generally as a robot or a robotically controlled instrument. A vision-based contact signal can be used with the robot end effector force F_{PSM}∈R³, and position measurements p∈R³, to derive an estimate of the effective stiffness k, of the material with which the end effector is in contact (where PSM indicates patient side manipulator). The stiffness in the Z direction requires separate values to be fit for tension and compression. While in contact, it is assumed that at time t,

$${F}_{PSM , t} \approx {k}^{( i )} {s}_{t} + {c}^{( i )} , \qquad ( 1 )$$

where F_{PSM} is the end effector estimated force in newtons based on joint torque readings,
sₜ=pₜ−p_{τ} is the end effector displacement in meters as measured from the most recent onset of contact at time τ, and
i is the ith demonstration.

Both k∈R³ and c∈R³ can be estimated for each of a plurality of demonstrations using linear least squares (or other methods) with units of newton per meter and newtons, respectively. Using the computed k, the contact-conditional force at time t for an ith demonstration, which is referred to herein as C_{V}-K_{PSM}, can be estimated as follows:

$${F}_{computed , t} = \{ \begin{matrix}k \text{?} s \text{?} & if in contact , \\ 0 & otherwise\end{matrix} . \qquad ( 2 )$$

$$\text{?} \text{indicates text missing or illegible when filed}$$

By way of example, to benchmark this approach, a best-case contact conditional force estimate C_{FS}-K_{FS} can be determined. This example uses the ground truth contact signal and the ground truth force to derive an estimate of k and force. To compare the contribution of the error from estimating k⁽ⁱ⁾ from the noisy F_{PSM} (as opposed to ground truth force), an intermediate approach, C_{V}-K_{FS}, can also be computed. In this intermediate approach, contact is estimated from vision, while k⁽ⁱ⁾ is estimated from the ground truth force. Additionally, the approach herein can be compared against the classic position difference method, PosDiff, in which:

$${F}_{computed , t} = {d}^{( i )} ( {p}_{des , t} - {p}_{t} ) + {e}^{( i )} , \qquad ( 3 )$$

where p_{des,t} is the desired position of the end effector at time t as reported by the dVRK.

The scaling constant d⁽ⁱ⁾ and offset e⁽ⁱ⁾ for the ith demonstration are estimated through linear least squares with respect to F_{PSM} using a similar assumption to Eq. (1).

Contact-Conditional Local Force Estimation with No-Robot State Information

In examples when working with clinical versions of a telesurgical robot, the robot state information is often inaccessible due to intellectual property protections. Thus, surgical skills analysis and sensory substitution haptic augmentations in clinical settings can rely purely on visual data streams. In this example, this constraint can be accommodated in the force estimation approach described herein. The measured stiffness constant is eliminated and a scaled measure of instrument (e.g., end effector) position through vision is estimated in a viewpoint generalizable manner. Even though the true force magnitude is not estimated, the scaled force variation can still provide a measure of tissue handling skill, and communicate performance-enhancing information through sensory perceptible feedback.

Certain aspects in the following description assume that geometric and optical parameters do not vary substantially for standard telesurgical systems (or other remote surgical or other robotically controlled systems), such as including stereo endoscope, and for other types of surgical tools (e.g., EndoWrist large needle drivers for a da Vinci surgical robot have the same geometries). In an example, a vision-based position estimator model (e.g., a neural network), which has been trained in a supervised manner on a robot with access to state information (e.g., robot joint encoders), generates an estimate of force. Alternatively, or additionally, the robot can be instrumented with position measurement apparatuses, such as infrared or electromagnetic marker tracking apparatuses. Once this initial training is done, the position estimator can be deployed on unseen systems, with the option of further fine-tuning of the model. The position estimator model can be designed to learn and consequently generalize from data across varying viewpoints. To achieve this, the position labels can be normalized by the range of their corresponding demonstration example, which can be expressed as follows:

$$\hat{p} \text{?} = \frac{p \text{?}}{p \text{?} - p \text{?}} , \qquad ( 4 )$$

$$\text{?} \text{indicates text missing or illegible when filed}$$

where \hat{p}ₜ⁽ⁱ⁾ represents the normalized position estimate of position pₜ⁽ⁱ⁾ at time t for demonstration i. The variables Pₘₐₓ⁽ⁱ⁾ and pₘᵢₙ⁽ⁱ⁾ min correspond to the maximum and minimum position attained in demonstration i.

Training on this scaled position estimate results in a unitless (e.g., normalized) position output from the position estimator. These outputs \hat{p}, are then used instead of p to compute sₜ in Eq. (2), with k⁽ⁱ⁾ being an arbitrary scaling constant. Thus, the new equation is

$${F}_{computed , t} = k \text{?} ( \hat{p} \text{?} - \hat{p} \text{?} ) . \qquad ( 5 )$$

$$\text{?} \text{indicates text missing or illegible when filed}$$

This position estimator-based approach, which is referred to herein as FullVision, does not require robot state information. However, in other examples, robot state information or other position sensing information (e.g., encoders, infrared sensors, or the like) can be implemented to augment the position estimator-based approach. For benchmarking, the approach described herein can use a priori knowledge of the ground truth force to fit the scaling constant using a similar assumption as in Eq. (1). This allowed for comparisons against the ground truth force measurement at similar scale.

### Vision-Based Contact Detection

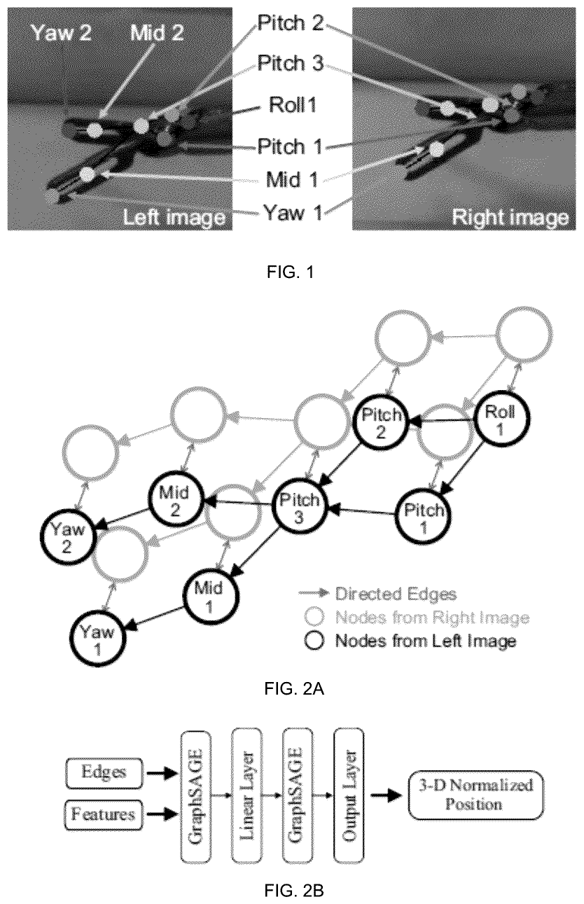

As a further example, to detect contact between the instrument and the environmental structure (e.g., between a manipulator and tissue), an EfficientNet architecture (e.g., EfficientNetB3) can be employed as the feature encoder, coupled with a binary classification head. Other models can be used in other examples. The model can be trained using crowd-sourced contact labels which eliminate the need for force sensor data. The normalized position estimator described hereinbelow can be used to appropriately center a crop window of 234 by 234 pixels on the manipulator. Other method can be used in other examples to center the window on the manipulator. This centered the crop on the keypoint “Mid 2” (FIG. 1). During the training phase, including random rotations, cropping, flipping, erasing and color jittering data augmentations were applied to the input images.

To validate using a state-of-the-art network EfficientNetB3 model over a smaller network, a small custom convolutional neural network model was also trained. This model consisted of six convolution layers with 8, 16, 32, 16, 8 and 4 channels, a kernel size of 3×3, and stride 2 for the first layer, and stride 1 for all other layers. Average pooling layers with stride two were placed after every three convolution layers. A fully connected layer of 100 hidden units connected to a final binary classification layer was used. All activations were Rectified Linear Units (ReLU). A pseudo-randomized grid search was performed to optimize the learning rate and L2 regularization weight. Both models were subjected to a training process spanning 150 epochs, with a batch size of 32, and were optimized using cross-entropy loss and the Adam optimizer. The model with the best performance on the validation set was chosen for evaluation.

### Vision-Based Normalized Position Estimation

### Keypoints Tracking

In examples where access to robot kinematic and camera parameters data is not available, keypoints tracking code (e.g., a keypoints model or other method) can be programmed to estimate a normalized three-dimensional (3D) end-effector position from image data (e.g., real-time or stored video data). For example, DeepLabCut can be executed to extract (e.g., identify) a set of geometric features (e.g., a network), referred to herein as keypoints. Other software (e.g., 3D DeepLabCut or other vision-based pose estimation software) can be used in other examples to extract the geometric features from the image data. In examples where the acquired images are 3D images, each of the geometric features can correspond to respective voxels. The keypoints tracking code further can determine locations coordinates) of pixels or voxels for each of the identified geometric features in the at least one image frame.

FIG. 1 illustrates an example of keypoints that can be used for end-effector instrument. In the example shown in FIG. 1, a total of eight keypoints for the instrument were used. Other numbers and/or different geometric features can be used to define the keypoint network in other examples, such as depending on the configuration of the portion of the instrument interacting with the environmental structure (e.g., tissue or other deformable structure). To fine-tune the keypoints tracking code (e.g., DeepLabCut) for the pose estimation task, a plurality of randomly sampled images can be selected from the training dataset. The output from DeepLabCut can be a multi-dimensional vector (e.g., a 32-dimensional vector) corresponding to the pixel coordinates for each keypoint in a stereo image pair, such as shown in the left and right images of FIG. 1, which are acquired by a pair of cameras. For example, each camera has a field of view including the distal portion of the instrument (e.g., end-effector) and the environmental structure with which the instrument is interacting and is configured to provide corresponding image data for the field of view. Any number of imaging device (e.g., optical imaging, ultrasound imaging or other imaging modalities) can be used to acquire respective images (e.g., real time two-dimensional or 3D images) from which the pixel coordinates are extracted for the keypoint network. In an example, training of the keypoints model was performed for 50,000 epochs on a Nvidia V100 graphics card.

### Graph Neural Network Position Estimator

It is desirable to provide a generalizable and scalable position estimator for an instrument (e.g., end effector or other remotely controlled instrument or tool) that can be deployed off-the-shelf or fine-tuned quickly on a new robot. Thus, the resultant model should be data-efficient to train and fine-tune. As one example to achieve this end, a Graph Neural Network (GNN) can be used to model the fixed geometric relation of the detected keypoints as nodes on a graph. Other types of neural networks, constitutive models or other types of models (e.g., a linear spring model, a Kelvin-Voigt model, a Yeoh hyperelastic model, etc.) can be used in other examples. For the example of GNN for estimating position of an end effector, directed edges between nodes are defined according to the end effector geometry. Next, respective eight undirected edges were added to connect corresponding nodes between the images acquired by one or more imaging devices (e.g., stereo image pairs acquired by stereo cameras). An example of full graph architecture that includes eight undirected edges connecting connect corresponding nodes is shown in FIG. 2A. The input features vector of each node used a one-hot encoding of the static graph structure. This can be concatenated with the horizontal and vertical normalized pixel coordinates to obtain an 18-dimensional vector. While no temporal relationships between keypoints from consecutive images in a video stream were modeled in the example of FIG. 2A, temporal relationships can be modeled in other examples.

FIG. 2B illustrates an example of a GNN that includes two GraphSAGE convolution layers with 512 hidden units. A fully connected layer comprising 512 hidden units was placed between the GraphSAGE layers. All activation functions were ReLU; though other activation functions can be used for the GNN. The model is trained to perform graph-level regression of three-dimensional position. Supervised learning can be performed by collecting three-dimensional position labels for each stereo image training pair. In one example, the training can utilize the robot encoder-based end effector position measurements (or other position sensing measurements), which can be normalized by their range in each demonstration. In a further example, a 4-by-4 hyperparameter grid search can be used to obtain a learning rate and L2 regularization of 0.001 and 0.0001, respectively. Training can be performed over 200 epochs using a batch size of 512. The chosen model was selected based on its performance on the validation set.

### Fully Connected Neural Network Estimator

As a further example, a custom Fully Connected Neural Network (FCN) can be constructed to benchmark the GNN model. The FCN has a symmetric architecture, comprising two identical sub-networks, one for each side of the stereo image pair. Each took as input the two-dimensional pixel coordinates of the eight keypoints identified through position estimation software (e.g., DeepLabCut), as shown in FIG. 1. This results in a 16-dimensional input vector. Each sub-network contained four fully connected layers with 16 hidden units with ReLU activation functions. The outputs from the sub-networks were fused using an additional fully connected layer with 32-dimensional input which then output a normalized three-dimensional position. A hyperparameter grid search was performed to select the learning rate and L2 regularization, with the chosen values for both parameters being 0.0001. Training was carried out for 200 epochs using a batch size of 32. As with the GNN, the chosen FCN model with the best performance on the validation set was selected.

### Example Datasets

### Artificial Silicone Tissue Dataset

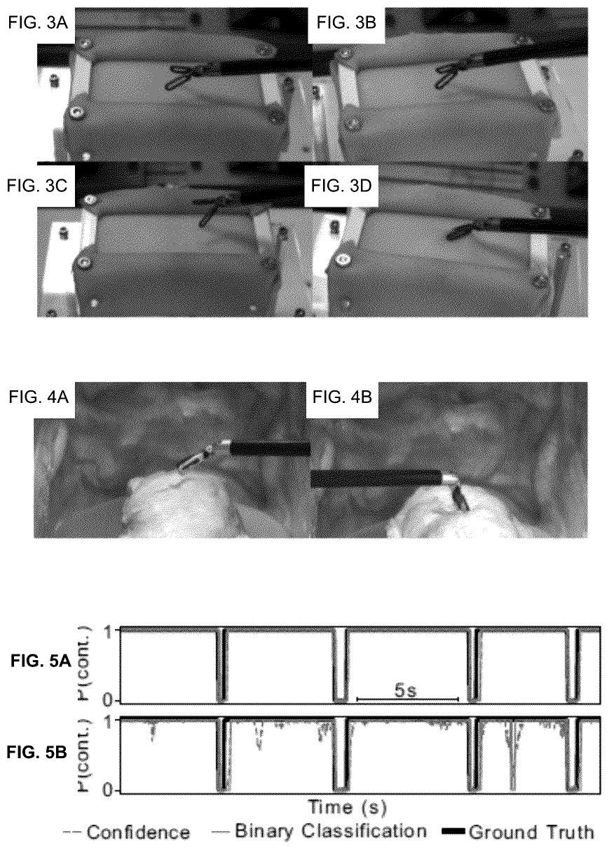

For example, a pre-existing dataset can be used, such as a dataset consisting of 46 demonstrations of one dVRK Patient-Side Manipulator (PSM) performing various retractions and palpation of manipulations on artificial silicone tissue. These were done under nine viewpoints and manipulator configurations such as shown in the photograph of FIG. 3. The dataset contained robot joint encoder current and desired positions, and current-based joint torque estimates. These data were collected at 1 KHz. Stereo image pairs, each of size 960×540 were collected at 30 Hz. The ground truth force data was collected from a six-axis Nano17 sensor (ATI Automation, Apex, NC) placed underneath the tissue. The camera parameters were unknown, which is a typical constraint for clinical data. This dataset was subsequently divided into training, validation and test sets. The training set and validation set comprised four configurations of 16 and 8 demonstrations containing a total of 56,098 and 28,107 examples, respectively. The test set contained demonstrations from the four training configurations and from six unseen configurations, resulting in a total of 22 demonstrations with 77,074 examples.

To benchmark the quality of human labels, contact labels were generated from ground truth force sensor data by classifying force magnitudes of above 0.2 N as being “in contact”. These sensor-labeled datasets was used to train a ground truth “GT” version of the vision-based contact detector.

### Transfer Learning to Realistic Dataset

In one example, to test the generality of our approach to a visually dissimilar dataset, a dataset was used that included 40 demonstrations of either a left-side or right-side PSM being used on raw chicken skin wrapped around chicken thigh (see FIG. 4). In the example of FIG. 4, the foreground contains an actual piece of chicken meat to be manipulated. Scalability is achieved by only fine-tuning on a small subset of this new dataset using human-generated labels instead of sensor-based labels. Such fine-tuning approaches have previously proven effective in transferring surgical gesture classification from benchtop scenarios to clinical-like data. Twelve demonstrations were used for training and the rest of the 28 demonstrations were used for testing. Both sets contain 21,073 and 49,374 images, respectively. To reduce labeling cost and training time, the dataset was downsampled by a factor of 45 and 10 for contact labeling and position estimation model training, respectively. This resulted in a total of 472 and 2,114 training examples, respectively. The test set was not downsampled. Using these training sets, the vision-based contact estimators and position estimators that were previously trained on the silicone dataset were fine-tuned using the same hyperparameters and number of training epochs as before. Because hyperparameters were kept the same as those used with the silicone dataset, no validation set was required. The best model was selected based on its optimal training performance over all training epochs. To fine-tune the DeepLabCut keypoint detection, 90 images from the training set were sampled and consequently tuned over 20,000 epochs.

Experiments were conducted to test the generality of the approach described herein to surgical scenes. For instance, contact detection, position estimation, and force estimation methods were benchmarked on the new dataset. Additionally, for the position estimator, the performance of the GNN and FCN were separately tested when training from scratch on different amounts of data. This was done without pre-training on the silicone dataset. Also, the data efficiency of visual contact and position estimation were investigated when fine-tuning on new data. This was done by varying the amount of additional realistic data used during fine-tuning, and assessing model performance on the test set.

### Results and Discussion

### Vision-Based Contact Detection

The accuracy metrics for vision-based contact detection are shown in Table 1. EfficientNet demonstrated consistently better performance regardless of the kind of training labels used. It achieved F1 scores of 0.985 and 0.975 when trained on force sensor-derived labels (GT), and human-derived labels (MTurk), respectively. In comparison, the small CNN achieved F1 scores of 0.979 and 0.948 on GT and MTurk labels, respectively. Comparing FIGS. 5A and 5B, EfficientNet's performance is superior to the small CNN, matching the ground truth contact signal more consistently. As shown by the nonthresholded predictions (dotted lines in FIGS. 5A and 5B), the small CNN prediction confidence fluctuated frequently, resulting in misclassifications especially during periods when contact was just made or just broken. The agreement of the performance of the models trained on the ground truth labels, and the MTurk labels, indicates that the use of human labels is comparable to using an actual force sensor to detect contact. Furthermore, there it has the added advantage being usable with clinical datasets that do not have accurate force measurements.

TABLE 1
Contact detection model performance metrics

| Model | | Silicone | | F1 | | Realistic | | |
|---|---|---|---|---|---|---|---|---|
| Label | Accuracy | Precision | Recall | Score | Accuracy | Precision | Recall | F1 Score |
| Small | 0.964 ± | 0.982 ± | 0.975 ± | 0.979 ± | 0.820 ± | 0.863 ± | 0.853 ± | 0.855 ± |
| CNN GT | 0.010 | 0.006 | 0.011 | 0.007 | 0.050 | 0.049 | 0.086 | 0.050 |
| MTurk | 0.916 ± | 0.992 ± | 0.908 ± | 0.948 ± | 0.848 ± | 0.861 ± | 0.909 ± | 0.882 ± |
| | 0.022 | 0.003 | 0.025 | 0.014 | 0.043 | 0.049 | 0.059 | 0.039 |
| EfficientNet GT | 0.975 ± | 0.983 ± | 0.988 ± | 0.985 ± | 0.875 ± | 0.844 ± | 0.988 ± | 0.909 ± |
| | 0.005 | 0.007 | 0.008 | 0.003 | 0.047 | 0.058 | 0.018 | 0.035 |
| MTurk | 0.959 ± | 0.990 ± | 0.960 ± | 0.975 ± | 0.899 ± | 0.873 ± | 0.986 ± | 0.925 ± |
| | 0.018 | 0.003 | 0.023 | 0.012 | 0.041 | 0.053 | 0.010 | 0.031 |

### Position Estimation Methods

Table 2 presents the accuracy metrics for the normalized position estimator. The error in the test set is reported in the normalized unitless scale. This represents a percentage error with respect to the distance traversed by the end-effector over the corresponding demonstration. For interpretability, Table 2 also reports RMSE errors at the scale of the test set demonstrations.

The results in Table 2 illustrate that both the normalized position estimators—the GNN model and the FCN model-exhibited comparable performance on the silicone dataset. The GNN model demonstrated an approximately 2% lower accuracy compared to the FCN model across all axes of force. This reduction in accuracy is expected given the shallow network structure of the GNN. This constraint is imposed by the sparseness of the geometry-based graph structure used, where adding more GraphSAGE layers would result in redundant messages being passed between nodes.

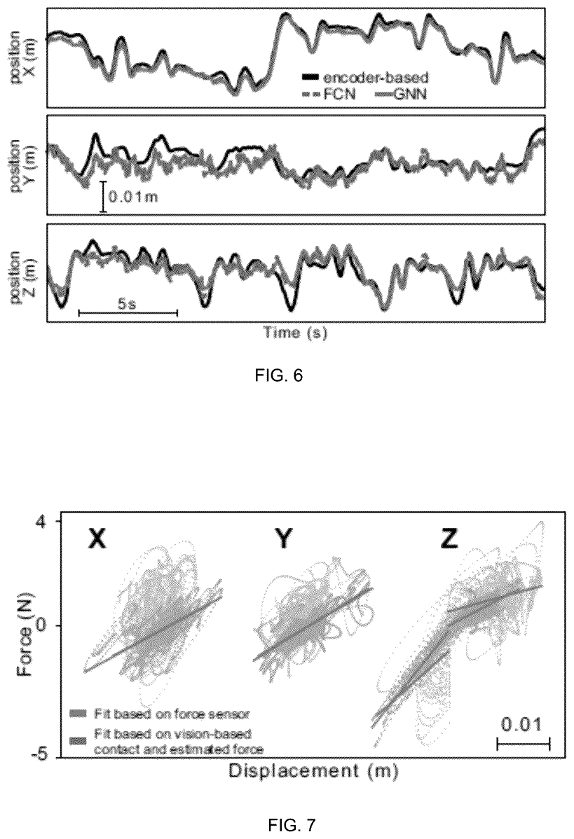

The comparison of visual predictions and actual positions, as depicted in FIG. 6, confirms that both models are able to model the movement trends of the ground truth end effector position. Both models more accurately captured the X and Z axes movements compared to the Y-axis movements. X and Z correspond to the left-right and up-down directions in the stereo images. Y corresponds to depth in the stereo image, which contains more ambiguity. When converted back into the scale of the test set, force estimates, the acceptability of positional accuracy will be evaluated based on force prediction accuracy, which is described below.

TABLE 2
Position error metrics for vision-based normalized position estimators.

| | | RMSE - normalized position (m/m)RMSE - rescaled position (m)* | | | | | | | |
|---|---|---|---|---|---|---|---|---|---|
| Dataset | Model | Overall | X | Y | Z | Overall | X | Y | Z |
| Silicone | GNN | 0.087 ± | 0.052 ± | 0.121 ± | 0.089 ± | 0.002 ± | 0.002 ± | 0.003 ± | 0.003 ± |
| | | 0.017 | 0.012 | 0.024 | 0.016 | 0.001 | 0.001 | 0.001 | 0.001 |
| | FCN | 0.085 ± | 0.047 ± | 0.122 ± | 0.085 ± | 0.002 ± | 0.001 ± | 0.003 ± | 0.003 ± |
| | | 0.020 | 0.011 | 0.031 | 0.017 | 0.001 | 0.000 | 0.001 | 0.001 |
| Realistic | GNN | 0.091 ± | 0.041 ± | 0.141 ± | 0.093 ± | 0.004 ± | 0.002 ± | 0.005 ± | 0.003 ± |
| | | 0.027 | 0.014 | 0.038 | 0.030 | 0.001 | 0.000 | 0.001 | 0.001 |
| | FCN | 0.088 ± | 0.043 ± | 0.133 ± | 0.087 ± | 0.003 ± | 0.002 ± | 0.005 ± | 0.003 ± |
| | | 0.027 | 0.014 | 0.040 | 0.028 | 0.001 | 0.000 | 0.001 | 0.001 |

Note:
*Normalized Position RMSE rescaled into the range of the test set for interpretability.

Contact-Conditional Local Force and Stiffness Estimation with Known Robot State Information Model-Based Stiffness Estimation

The average estimated stiffnesses of the manipulated materials are reported in Table 3. As it was derived from force sensor data, the estimated stiffness from C_{FS}-K_{FS} functions as the ground truth reference stiffness. Comparing this estimate against C_{V}-K_{PSM}, the differences in the mean stiffness were −44, +37, +1, −10 nm⁻¹ in the X, Y, Z⁺ and Z″ directions, respectively. Thus, the average error was 13% across all directions, with a maximum error of 26% in the X direction. This is comparable to the limits of human stiffness discrimination without visual feedback, which has a Weber Fraction of 23%. However, it is above 14% Weber Fraction for stiffness discrimination with visual feedback. This suggests that the contact conditional stiffness estimation approach is promising, but does require a more accurate estimate of force to facilitate tissue differentiation tasks. FIG. 7 shows a representative example of the fitted stiffness values based on the different sources of force data. For example, a stiffness model can be fit for the material that is being manipulating such as in circumstances where the robot joint torques (e.g., robot state information) is available. In other examples, the method can use known data from materials to train the stiffness model (e.g., from a “material library”).

TABLE 3
Estimated stiffness of manipulated materials.

| | | | Stiffness (Nm⁻¹) | | |
|---|---|---|---|---|---|
| Dataset | Model | X | Y | + Z | −Z |
| Silicone | CFS-KFS | 168 ± 47 | 182 ± 44 | 108 ± 25 | 332 ± 52 |
| | CV-KFS | 170 ± 46 | 185 ± 44 | 107 ± 25 | 335 ± 51 |
| | C_{V}-K_{PSM} | 124 ± 41 | 219 ± 60 | 109 ± 58 | 322 ± 104 |
| Realistic | CFS-KFS | 126 ± 36 | 131 ± 55 | 96 ± 29 | 245 ± 148 |
| | CV-KFS | 126 ± 36 | 131 ± 55 | 98 ± 33 | 246 ± 148 |
| | C_{V}-K_{PSM} | 94 ± 78 | 119 ± 105 | 135 ± 88 | 239 ± 124 |

### Force Estimation

Table 4 presents the average Normalized Root Mean Square Error (NRMSE) of the predicted force. This is computed with respect to the ground truth force sensor measurements over all test demonstrations. The top rows present contact conditional methods that use robot position information, with different sources of contact and force information: C_{FS}-K_{FS}, C_{V}-K_{FS} and C_{V}-K_{PSM}. These are benchmarked against F_{PSM} and PosDiff force estimates. The NRMSE in each force direction can be calculated element-wise as follows:

$$N R M S E = \frac{\sqrt{\frac{1}{N} \sum \text{?} {( {F}_{computed , n}^{( i )} - F \text{?} )}^{2}}}{F \text{?} - F \text{?}} , \qquad ( 6 )$$

$$\text{?} \text{indicates text missing or illegible when filed}$$

where F_{computed} is the computed force estimate, F is the ground truth force as measured from the force sensor, Fmax is the maximum force observed, Fₘᵢₙ the minimum force, and N is the number of data points, in the ith demonstration.

C_{V}-K_{PSM} showed lower mean NRMSE in all directions compared to force estimates based on joint torques (F_{PSM}). C_{V}-K_{PSM} also outperforms PosDiff which is a traditional approach to providing a scaled form of haptic feedback. The advantage of C_{V}-K_{PSM} is that it is less sensitive to the internal manipulator dynamics that affect F_{PSM} and PosDiff. Critically, the NRMSE of the norm (i.e. magnitude) and in each direction of C_{V}-K_{PSM} on the silicone dataset is below the 10% scaling threshold identified by Huang et al. for degraded teleoperated palpation. This threshold also corresponds to the average human force JND of 10%. Our results thus indicate that contact-conditional force estimation for force feedback has potential to improve telesurgical manipulation.

The increase in error between C_{FS}-K_{FS} and C_{V}-K_{FS} was smaller than that between C_{V}-K_{FS} and C_{V}-K_{PSM}. This suggests that there was a larger error contribution from the stiffness estimation (K_{FS} versus K_{PSM}) than from the contact detection (C_{FS} versus C_{V}).

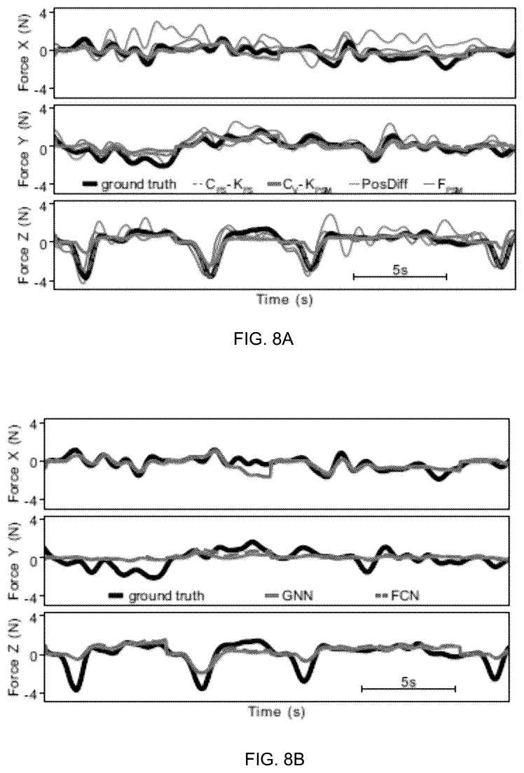

The large increase in error from C_{V}-K_{FS} to C_{V}-K_{PSM} in the Z direction was likely due to the higher overall stiffness in the Z direction. In FIG. 8, C_{V}-K_{PSM} shows general tracking of force variation. However, it displays underestimation in the Z direction at high compression forces compared to CFS-KFS.

TABLE 4
Normalized RMSE of force estimates of different force estimation
methods force sensor measurements with respect to

| | | | | NRMSE (N/N) | | | | |
|---|---|---|---|---|---|---|---|---|
| | | Silicone | | | | | Realistic | |
| Method | Norm | X | Y | Z | Norm | X | Y | Z |
| With robot | 0.079 ± | 0.192 ± | 0.141 ± | 0.129 ± | 0.198 ± | 0.330 ± | 0.247 ± | 0.265 ± |
| state F_{PSM} | 0.017 | 0.032 | 0.043 | 0.034 | 0.088 | 0.119 | 0.082 | 0.137 |
| CFS-KFS | 0.052 ± | 0.107 ± | 0.092 ± | 0.052 ± | 0.060 ± | 0.072 ± | 0.097 ± | 0.080 ± |
| | 0.007 | 0.017 | 0.016 | 0.009 | 0.011 | 0.014 | 0.018 | 0.025 |
| CV-KFS | 0.053 ± | 0.107 ± | 0.092 ± | 0.055 ± | 0.060 ± | 0.072 ± | 0.097 ± | 0.081 ± |
| | 0.008 | 0.017 | 0.016 | 0.010 | 0.011 | 0.014 | 0.018 | 0.025 |
| C_{V}-K_{PSM} | 0.068 ± | 0.106 ± | 0.090 ± | 0.090 ± | 0.097 ± | 0.107 ± | 0.136 ± | 0.149 ± |
| | 0.015 | 0.012 | 0.021 | 0.022 | 0.042 | 0.030 | 0.039 | 0.107 |
| PosDiff | 0.088 ± | 0.127 ± | 0.118 ± | 0.129 ± | 0.132 ± | 0.153 ± | 0.170 ± | 0.189 ± |
| | 0.007 | 0.016 | 0.023 | 0.016 | 0.052 | 0.059 | 0.060 | 0.084 |

| | | | | | | | |
|---|---|---|---|---|---|---|---|
| Without robot state* | 0.115 ± | 0.126 ± | 0.093 ± | 0.081 ± | 0.085 ± | 0.130 ± | 0.108 ± |
| FullVision (GNN) | 0.014 | 0.015 | 0.022 | 0.012 | 0.014 | 0.025 | 0.030 |
| 0.077 ± 0.013 | | | | | | | |
| FullVision (FCN) | 0.116 ± | 0.121 ± | 0.093 ± | 0.081 ± | 0.085 ± | 0.127 ± | 0.103 ± |
| 0.076 ± 0.013 | 0.014 | 0.015 | 0.026 | 0.010 | 0.015 | 0.021 | 0.024 |

Note:
*Force estimates were rescaled to match force scaling of the test data to allow for interpretable comparison.

The C_{V}-K_{PSM} force estimates in FIG. 8 show occasional instances of poor contact classifications that caused the contact condition to change abruptly. This resulted in the predicted force decreasing to zero sharply instead of smoothly like with the ground truth. These abrupt force deviations can potentially cause tissue damage if teleoperating with direct force feedback. Strategies to eliminate this include implementing a smoothing filter on the force. Given that direct force feedback also has to contend with the safety concerns of control instability, haptic sensory substitution can provide a more promising use case for the contact-conditional visual force estimates in some examples.

Contact-Conditional Local Force Estimation with No Robot State Information

The last two rows of Table 4 present the NRMSE of the force estimation methods with no robot state information. Here, the unitless force estimates are rescaled to match that of the test set for interpretability. The accuracies of both the GNN and FCN vision-only force estimation methods are shown to be comparable to those using F_{PSM}, a method that requires robot state information. In the Y direction, there is notable force underestimation. This error can be largely attributed to the low positional accuracy of the normalized position estimates in the Y direction (see, e.g., Table 2 and FIG. 6). Despite this, both GNN and FCN methods show tracking of force variations, indicating the viability of such methods for obtaining a general measure of tissue handling force.

The rescaling used linear least squares to tune the stiffness parameter to best match ground truth. This can come at the expense of presenting more force variation. Alternatively, presentation of force variation can be cimproved by increasing the stiffness parameter and trading off some accuracy. As described herein, haptic sensory substitution is a highly viable method of presenting such sensory perceptible feedback (e.g., audible, visual, and/or physical feedback) based on the estimated force. When used in this manner, representation of the force is now arbitrarily scaled such that accurately tracking relative force variations is more important than estimating exact force magnitudes.

### Generality of Approach to Novel Surgical Scenes

Table 1 presents the performance metrics for each finetuned contact detection model on the realistic dataset. When trained on MTurk labels, EfficientNet exhibited a decrease in F1 score of approximately 5% compared to the results on the silicone dataset.

The small CNN had a decrease of approximately 7%. Due to its simpler architecture, the small CNN model exhibited poorer generalization performance on the new dataset. This justifies our choice of using a state-of-the art vision classifier.

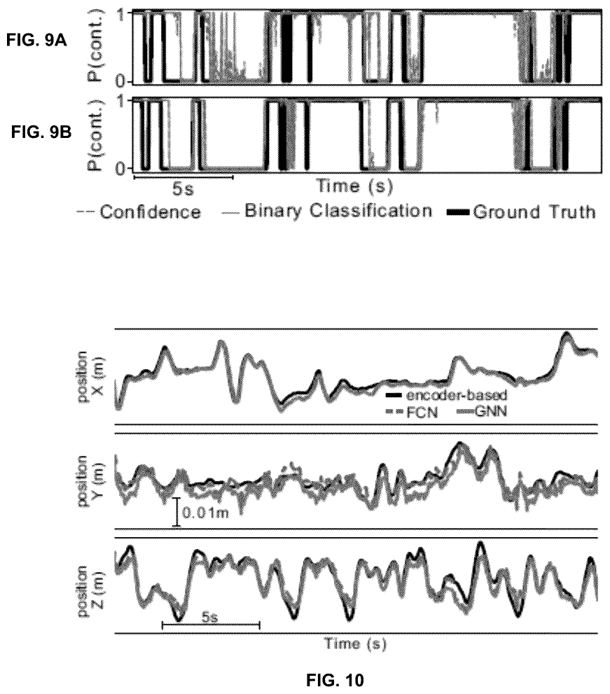

On the realistic dataset, the F1 scores when the models were fine-tuned on ground truth labels were lower than when fine-tuned on the MTurk labels. Analysis of the video revealed that the chicken skin would plastically deform during manipulation. Thus, there were instances when the end effector would be grasping the chicken skin, but the forces as measured by the force sensor were low enough for a “no-contact” classification. Under these conditions, the human labels were more accurate and less noisy than the “ground truth” force sensor-based classifications. This observation explains the decrease in F1 scores on the realistic dataset compared to the silicone dataset for models trained on MTurk labels. In this scenario, the false positive rate (as measured by precision in Table 1) increased. The effect of this contact uncertainty in the force sensor labels can be seen in FIG. 9. Here, the model that was trained on force sensor contact labels (FIG. 9A) displayed more fluctuation in prediction confidence compared to the model that was trained on MTurk labels (FIG. 9B). The latter also showed more “false positives” as defined by the ground truth, which was based on contact derived from force sensor data.

As indicated in Table 2, the position estimation methods described herein can retain similar performance levels as observed in the silicone dataset. Thus, minimal fine-tuning is required to achieve good performance. This indicates that the proposed keypoint-based approach to position estimation exhibits data efficiency. FIG. 10 depicts an example of scaled position predictions using the GNN and FCN compared to the joint encoder-based position estimated of the end effector on the realistic dataset.

The average estimated stiffness k for the realistic dataset is listed in Table 3. The difference in mean stiffness between C_{FS}-K_{FS} and C_{V}-K_{PSM} was −32, −12, +39, −6 Nm⁻¹ in the X, Y, Z⁺ and Z directions, respectively. Thus, the average error was 19% across all directions with a maximum error of 41% in the Z⁺ direction. The low stiffness of the chicken skin in the Z direction made stiffness estimates more sensitive to the noisy device dynamics. Thus, in its current form, the contact conditional force estimation methods might have limited applicability to differentiation tasks involving very soft tissues. However, the contact conditional force estimation models described herein can be adapted for very soft tissues based on this disclosure.

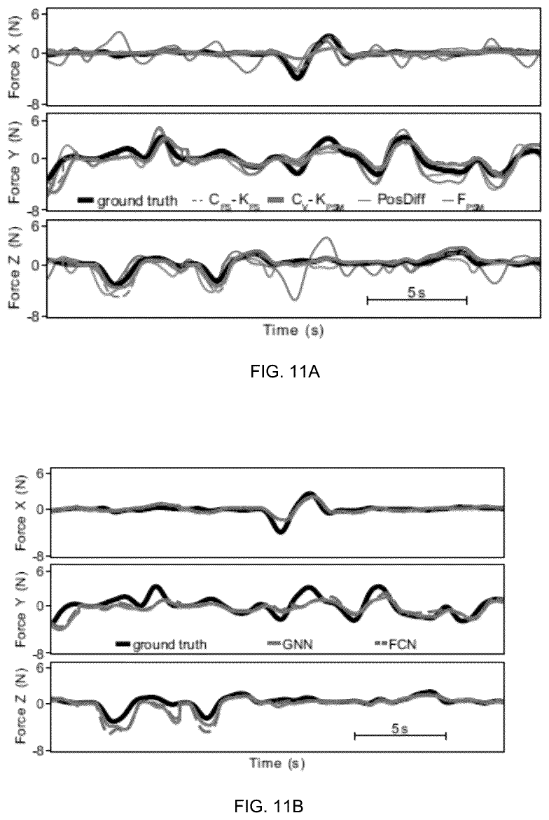

Consistent with earlier findings on the silicone dataset, Table 4 demonstrates that C_{V}-K_{PSM} yielded a lower average NRMSE compared to both joint torque-based force readings and PosDiff. The marginal increase in error observed between C_{FS}-K_{FS} and C_{V}-K_{FS} was significantly lower than the discrepancy seen between C_{V}-K_{FS} and C_{F}-K_{PSM}. Similar to the silicone dataset, this pattern indicates the large error contribution of K_{PSM}. The high Z force error is explained by the high error in the fitted stiffness constants in that direction. The high Y force error is due to occurrences of poor stiffness fits at the individual demonstration level. This was in part due to the plastic deformation of the chicken skin identified earlier in this section. The contact would be detected, but zero force would be exerted on the chicken skin, leading to erroneous stiffness measurements. The poor stiffness fits were partially masked within the aggregate computation of the mean stiffness. One possible approach to reducing the impact of this issue is to use a prior known tissue stiffness. This stiffness can then be conditionally updated during or after completion of the demonstration. Despite the relatively degraded stiffness estimates, C_{V}-K_{PSM} generally tracks force variation effectively, with the same trends as that of the silicone dataset, as shown in FIG. 11.

### Data Efficiency Experiments

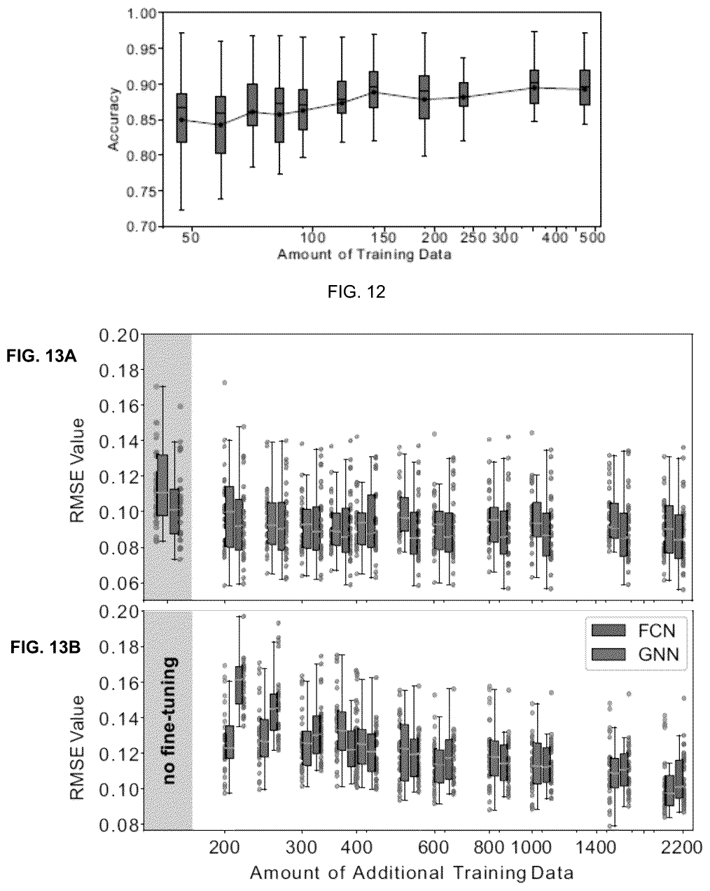

For the contact estimation, the EfficientNet model pre-trained on the MTurk contact labels from the silicone dataset was considered. Models that were finetuned with increasing amounts of MTurk labels from the realistic dataset were fit. The results presented in FIG. 12 show that mean contact prediction accuracy began at a low of 85% when the model was fine-tuned on only 50 additional examples. It gradually approached 90% as the number of fine-tuning examples increased. The largest gains were seen between the range of 50-150 examples. This suggests that a very low amount of additional labeled fine-tuning data is required to approach peak performance on a new dataset.

For position estimation, it has been hypothesized that the model's abstract keypoint representation enables zero-shot transfer. Thus, performance of the FCN and GNN models initially pre-trained exclusively on silicone data were evaluated. They were subsequently fine-tuned with up to 2200 additional examples of end effector position data. For example, the fine-tuning datasets, that the number of examples used to fine-tune DeepLabCut keypoint identification can be restated as only 90 images. The results shown in FIG. 13A indicate that without additional fine-tuning, the FCN performed better than the GNN. Fine-tuning the FCN on only 200 examples from the realistic dataset results in performance that approaches the performance of models that used the full realistic training set. While the GNN showed less generalizability to a novel dataset, it can also be fine-tuned on a small amount of data, requiring approximately 300 additional examples to approach peak accuracy. Thus, our results suggest that the deeper and less constrained FCN has stronger representational flexibility. Therefore, it showcased better suitability for zero-shot transfer and fine-tuning.

On the other hand, the GNN is better suited to novel deployments from scratch. This makes useful in clinical contexts where very little training data exists. FIG. 13B shows the data-efficiency of the FCN and GNN models when trained from scratch (without pre-training on the silicone dataset). Here, the GNN had quicker convergence to peak accuracy than the FCN. Our results are thus consistent with other studies of fine-tuning for transfer learning to clinical-like data.

The systems and methods described herein can further account for the influence of trocar forces on the resultant joint torque estimates of the robot. These forces affect the accuracy of fitting local stiffness models based on torque estimates. Compared to end effector force sensing, trocar force sensing is more feasible to implement, given that the requirements for miniaturization and biocompatibility are less strict. Such trocar-based force sensing can be used to augment the force estimation approach or learn a compensation model.

The systems and methods described herein can further use of dynamic models of the robot to improve the accuracy of stiffness estimates that are derived from robot state information.

The normalized position estimates learned through a GNN or FCN described herein can be enhanced by fitting precision camera models for a stereo endoscope, vision-based estimation algorithms, and/or further developing learning-based 3D reconstruction methods like Neural Radiance Fields. Such enhancement can leverage both the geometric graph structure that leads to data-efficient learning, and the deeper layers that were featured in the FCN.

The systems and method described herein further can be configured to account for slip. This can be obtained via visual estimation or through in-built slip detection capabilities. Additionally, nonlinear stiffness models (e.g., different constitutive models) can be used to improve the quality of force estimation described herein. Such models can provide useful force information when tissues are stretched to high displacements that might induce tearing.

Also, or alternatively, the models used herein can be refined based on user studies that compute various automated performance measures of tissue handling skill, based on contact-conditional vision-based force estimates. Testing of these estimates for both direct and sensory substitution force feedback will also be conducted to evaluate potential benefits for real-time telesurgical manipulation or other remote robotically controlled instruments.

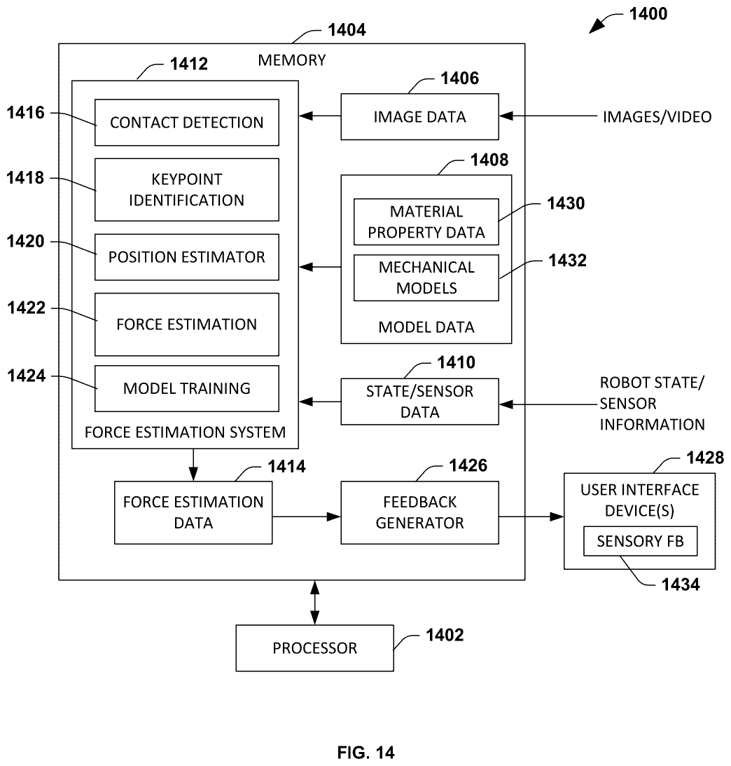

FIG. 14 depicts an example force sensing system 1400. The system 1400 provides an example implementing the methods and functions described herein above. Therefore, the description of FIG. 14 also can refer to certain aspects of the foregoing description. The system 1400 can be implemented in one or more computing devices and thus includes one or more processors 1402 and memory (e.g., one or more non-transitory computer-readable media) 1404. The memory 1404 stores data and executable instructions to perform the functions and method described herein.

In the example of FIG. 14, the data can include image data 1406, model data 1408, state/sensor data 1410. The instructions can include a force estimation system 1412 that, when executed by the processor 1402, cause the processor to generate force estimation data 1414 based on the image data 1406. As described herein, in some examples the force estimation system 1412 can be programmed to generate the force estimation data 1414 based on the image data 1406 and one or more of the model data 1408 and/or the state/sensor data 1410. That is, the image data 1406, the model data 1408, and/or the state/sensor data 1410 can individually or in any combination thereof constitute inputs provided to the force estimation system 1412, including as to the respective methods or functions (e.g., models) that form the force estimation system. The model data 1408 can be a library or database that includes material properties data 1430 and mechanical model data 1432. The material properties data can include a list of mechanical properties (e.g., stress, strain, stiffness, elasticity, ductility, kinematics, etc.) for one or more structures with which the instrument may contact. The mechanical models 1432 can further include a number of different constitutive mechanical models for different types of materials, which can be used selectively by the force estimation system 1412.

The image data 1406 can include one or more image frames of a portion of a region of interest, which includes instrument (e.g., end effector, manipulator or other tool) and an environmental structure with which the instrument is adapted to interact. In one example, the image data 1406 includes real-time image stream (e.g., video) acquired by one or more imaging devices. The imaging devices can be implemented as optical imaging devices (e.g., cameras, microscopes that record images in the visible spectrum), infrared cameras, ultrasound transducers, or other imaging modality configured to acquire 2D or 3D images of a region of interest. Thus, the image data 1406 can be a 2D spatial visualization (e.g., an image across a plane) or 3D spatial visualization (e.g. an image across a volume), and thus the image data can include pixels or voxels, accordingly. The analysis and processing of the images disclosed herein thus can be implemented with respect to the pixels or voxels in the image data 34 and/or information derived from the pixels or voxels. The image data can be acquired by one or more imaging devices at a sample rate, which can be programmable, over one or more time intervals and each image frame can include a time stamp.

In the example of FIG. 14, the force estimation system 1412 includes a plurality of functions or methods demonstrated as contact detection code (e.g., also referred to as a contact detector) 1416, keypoint identification code (e.g., also referred to as a keypoints detector or keypoints model) 1418, a position estimator (e.g., also referred to as position estimation code) 1420, and force estimation code (e.g., also referred to as a force estimator) 1422. Each of the respective functions or methods 1416, 1418, 1420, 1422 can be implemented as a respective model. The force estimation system 1412 can include one or more a model training function 1424, which can be programmed to train the respective models. The model training function 1424 can be programmed to implement any of a variety of techniques for generating the respective models, including support vector machines, regression models, self-organized maps, k-nearest neighbor classification or regression, fuzzy logic systems, data fusion processes, boosting and bagging methods, rule-based systems, or artificial neural networks.

As an example, the model training function 1424 can be configured to train the contact detector 1416 by giving labeled images from crowd-source labelers, which can include a number of labelers, such as including non-medically-trained people. The model training function 1424 can train the keypoints detector 1418 by non-medically-trained humans, such as described herein. The model training function 1424 can train the position estimator model 1420 by providing labeled data from position sensors (e.g., optical through a vision-based marker tracking system, mechanically via joint encoders representative of joint space angles, and/or a marker tracking system). The model training function 1424 can train the force estimator model 1422 with contact conditional programming based on contact as a hand designed model (e.g., the force estimator 1422 can be trained to act as a constitutive model). For example, the force estimator 1422 can be trained implement as a simple linear stiffness model, though the force estimator 1422 can be trained to act as other forms of constitutive models, which can depend on the material properties of the environmental structure. The force estimator model 1422 thus can represent relationships between physical quantities that represent different aspects of material properties/behavior of the environmental structure responsive to interactions with the instrument. For example, the force estimation model can be a neural network trained on state information derived from the instrument and/or position measurements of the instrument with corresponding labeled images representative of an instrument interacting with an object.

The contact detector (e.g., a trained neural network model) 1416 is programmed to detect contact between the portion of the instrument and the environmental structure. For example, the contact detector 1416 is a neural network configured to classify a contact condition between a portion of the instrument (e.g., an end effector or other portion thereof) and the environmental structure based on at least one image frame in the image data 1406. The contact detector 1416 can be trained to classify the contact condition as a contact condition or a non-contact condition. For example, the contact detector model 1416 takes as input a single image frame a camera having a field of view (e.g., real-time or recorded) robot manipulation scene, in which the material being manipulated by the instrument is deformable. The contact detector model 1416 outputs a classification (with uncertainty bounds) specifying whether the instrument has made contact or no contact with the environmental structure (e.g. tissue). The contact detector can continue to repeatedly classify the contact condition for acquired image frames provided by the image data 1406.

An image frame (e.g., from a single camera) or multiple image frames (e.g., from multiple cameras) are applied as inputs the keypoints model (e.g., a trained neural network model) 1418. The keypoints model 1418 is programmed to extract a set of geometric points of the portion of the instrument. The set of geometric points represent a geometric relationship (in a 2D or 3D spatial domain) of locations distributed across the instrument. In one example, the set of geometric points define a stick model of the portion of the instrument (e.g., an articulated end effector). The keypoints model 1418 further can be programmed to determine coordinates of the pixels or voxels in each image frame based on the extracted set of geometric points.

The position estimator (e.g., a trained neural network model) 1420 is programmed to estimate a 2D or 3D spatial position or displacement of the portion of the instrument to provide an estimated spatial position or displacement for the instrument based on the image data 1406 (e.g., based on one or more image frames). For example, the set of geometric points (e.g., coordinates of pixels or voxels) determined by the keypoints model 1418 can be provided as inputs to the position estimator 1420. The position estimator is programmed to predict a 3D position of the portion of the instrument (e.g., an end effector) based on the inputs from the keypoints model 1418. In some examples, the position estimator 1420 can be configured to provide a three-dimensional normalized position or displacement for the portion of the instrument based on the pixel or voxel coordinates in the at least one image frame. Thus, the position or displacement can be determined at an arbitrary or known length scale.

In some examples, the position estimation model 1422 further is programmed to compute the estimated position or displacement based on additional position data, shown as the state/sensor data 1410, being provided as additional inputs to the position estimation model. For example, the state/sensor data 1410 represent one or more measured parameters associated with a joint space for the instrument (e.g., joint angles, encoder readings, and the like). Also, or alternatively, the state/sensor data 1410 can include sensed positions for the portion of the instrument, such as vision-based methods, electromagnetic method and the like.

As a further example, the position estimator 1420 can be configured to track the estimated spatial position or displacement for the instrument over a time interval based on a series of image frames (e.g., tracking position or displacement from one frame to the next frame). For example, the position or displacement tracking can be from when an initial contact between the instrument and the environmental structure is detected (e.g., by the contact detection model 1416) and continue while the contact is continually detected. Alternatively, the position or displacement tracking can include any set of frames so long as contact between the instrument and the environmental structure is detected in such frames.

The force estimation code 1422 (e.g., a trained neural network model) can be configured to estimate (e.g., predict) a measure of force between the instrument and the environmental structure based on the estimated spatial position or displacement for the instrument. The estimated spatial position or displacement provided by the position estimator 1420 can be a three-dimensional normalized position or displacement for the portion of the instrument. As described herein, the force estimation can be contact conditional. For example, the force estimation code 1422 can be executed responsive to the classified contact condition between the instrument and the environmental structure (e.g., input from the contact detection code 1416). For example, if there is contact between the instrument and the environmental structure, the force estimation model 1422 can store the robot position and/or displacement (e.g., input from the position estimator 1420) when the contact was first initiated, and the track the position throughout the time interval so long as the contact state continues (e.g., as estimated by the contact detection code 1416). The force estimation model 1422 can receive the tracked position or displacement as inputs to the model and predict an estimate of the measure of force that is exerted by the tool on the environmental structure (e.g., tissue). Also, in some examples, the force estimation model 1422 can receive an estimated speed or velocity in addition to the tracked position or displacement as inputs to the model to predict the estimated measure of force.

As described herein, the position estimation model 1420 can determine a plurality of discrete normalized position and/or displacement values over a time interval during the contact condition. In such example, the plurality of discrete normalized position and/or displacement values are applied as inputs to the force estimator model 1422 for computing (e.g., predicts) the estimated the measure of force between the instrument and the environmental structure at one or more times or continually throughout the time interval.

In some examples the force estimation system 1412 can include a contacted-material identification network to automatically (or semi-automatically) select and/or configure one or more of models 1416, 1418, 1420, and 1422 according to the environmental structure. The environmental structure with which the instruments is to interact can be specified in response to user input instructions via a user interface device 1428 or through an automated detection method (e.g., tissue detection model). As an example, the tissue detection model takes inputs from the contact detection 1416 and the keypoint identification 1418 and semantically segments (e.g., segment and identify/classify the image of) the environmental structure (e.g., different tissue, anatomy, or other environmental structure). In response to detecting contact (e.g., by contact detection 1416), the force estimation system can include code programmed to query the position of the contact from the pixel values in and output a predicted type of environmental structure that the instruments is contacting. The predicted type of environmental structure thus can change as a function of the position of contact over time. The force estimation system 1412 can provide the predicted type of environmental structure to the model data 1432, which can load the correct constitutive model into the force estimation code 1422 based on the predicted environmental structure in contact. Accordingly, the model can dynamically update responsive to the type of environmental structure that the instrument contacts.

As a further example, the force estimation system 1412 can be configured to implement code programmed to implement adaptive stiffness tuning. For example, the adaptive stiffness tuning code can takes as input estimated force data from a secondary source, such as a sensor that can measure and/or estimate joint torques or end-effector forces, to compute the estimated end-effector forces based on a kinematic or dynamic model of the instrument (e.g., a robotically controlled instrument). The adaptive stiffness tuning code further can receive as input the contact condition from the contact detector 1416 and store the estimated end-effector forces based on a kinematic or dynamic model of the robot when contact is indicated together with the tracked position determined by the position estimator 1420. The adaptive stiffness tuning code further can be configured to employ a non-linear or linear regression method to fit the parameters of the force estimation model 1422 based on the stored estimated end-effector forces data and the model can be updated accordingly.

In some examples, the system can be configured to generate a sensory perceptible feedback for a user based on the estimated measure of force (e.g., provided by the force estimation 1422). The sensory perceptible feedback comprises at least one of audible feedback, visual feedback, and/or physical (e.g., haptic) feedback. For example, the memory 1404 includes instructions, shown as a feedback generator 1426, programmed to provide (e.g., through a communications link) one or more feedback signals to control the one or more user interface devices 1428 to provide the sensory perceptible feedback. In examples where the instrument is a robotically controlled instrument and the environmental structure comprises biological tissue and/or other structures on or within a region of interest, the user interface device 1428 can also be in communication with the robotically controlled instrument (e.g., through a communications link) and be a remote control configured to control positioning and/or other functions of the robotically controlled instrument responsive to user inputs through the interface device. The user interface device 1428 configured to provide the sensory perceptible feedback. The type and configuration of the user interface device 1428 can depend on the application and type or robotically controlled instrument. In some examples, the robotically controlled instrument is a robotic surgical tool, such as various tools available from or being developed by Auris Health, Medtronic, Stryker, Zimmer Biomet, and others. The user interface device 1428 can include one or more of a joystick, a screen, a foot pedal, a wearable device (e.g., glove or garment), augmented reality goggles, a smartphone, and the like, which can provide a corresponding sensory perceptible feedback responsive to the feedback signal provided by the feedback generator. There can be any number of one or more such user interface devices, and each user interface device can include one or more sensory feedback mechanisms 1434, such that one or more types of sensory perceptible feedback can be provided based on the feedback signals. The sensory feedback mechanisms 1434 can include one or more speakers configured to provide audible feedback such as a tone, command, or other sound. Also, or alternatively, the sensory feedback mechanisms 1434 can include one or more lights or a screen configured to provide visual feedback, such as a light or an image. Also, or alternatively, the sensory feedback mechanisms 1434 can include actuators, motors, or the like integrated into the user interface device(s) 1428 configured to physical feedback can include direct force feedback, haptic feedback, or the like, which the sensor feedback mechanism 1434 is adapted to apply to a portion of the user interface device (e.g., a lever, joystick, clamp etc.). Other types of user interface devices 1428 and respective sensory feedback mechanisms 1434 can be used in other examples.

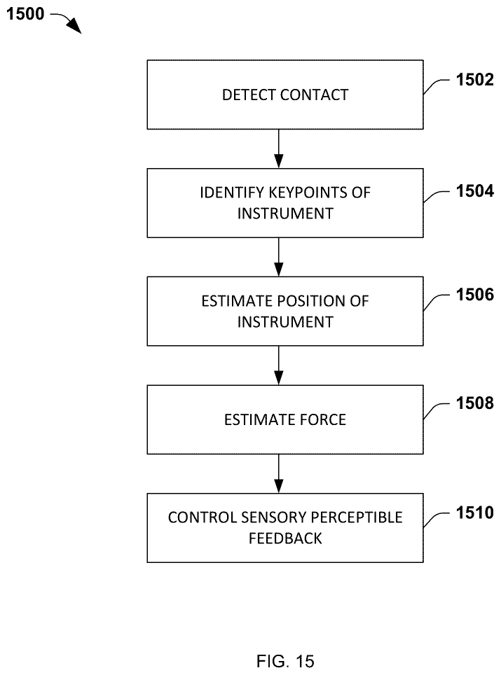

In view of the foregoing structural and functional features described above, example methods that can be implemented will be better appreciated with reference to the flow diagram of FIG. 15. While, for purposes of simplicity of explanation, the method of FIG. 15 is shown and described as executing serially, it is to be understood and appreciated that such methods are not limited by the illustrated order, as some aspects could, in other examples, occur in different orders and/or concurrently. Moreover, not all illustrated features may be required to implement a method. The method or portions thereof can be implemented as instructions stored in one or more non-transitory machine readable media and be executed by a processor of one or more computer devices, for example. Various aspects of the method 1500 can be implemented by the systems and methods described herein. Accordingly, the method 1500 may refer to certain aspects of foregoing description and figures.

At 1502, the method 1500 includes detecting contact between the instrument and the environmental structure. In an example, the detecting at 1502 includes classifying (e.g., by contact detection model 1416) an interaction between the instrument and the environmental structure as one of a contact condition or a non-contact condition based on an analysis of at least one image frame. The contact detection can be repeated for each image frame in the image data. The contact detection performed continually at a rate at which the image frames are received or at another rate to provide contact classification data indicative of whether or not contact is made in the respective image frame. An initial contact event can be flagged in contact data that is provided.

At 1504, the method 1500 includes identifying keypoints of a portion of the instrument. For example, the keypoint identification at 1504 includes identifying (e.g., by keypoint identification model 1418) geometric features (e.g., a network of keypoints) of the portion of the instrument based on the at least one image frame. Locations (e.g., 2D or 3D coordinates) of pixels or voxels are also determined for each of the identified geometric features in the at least one image frame.

At 1506, the method 1500 includes estimating a spatial position of a portion of the instrument to provide an estimated spatial position for the instrument based on image data. For example, the estimating a spatial position includes determining (e.g., by position estimation model 1420) a spatial position based on the locations of the pixels or voxels for the identified geometric features (provided at 1504) for the respective image frame or a cropped portion of the image frame. The estimated spatial position can be tracked for the instrument over a time interval, such as from an initial time when the contact condition is detected and while the contact condition is maintained. In an example, the position estimation model is configured to provide a three-dimensional normalized position for the portion of the instrument based on the pixel or voxel coordinates determined for the keypoints in the at least one image frame.

At 1508, the method 1500 includes estimating (e.g., by force estimation model 1422) a measure of force between the instrument and the environmental structure based on the spatial position for the instrument estimated at 1506. For example, the estimating of the measure of force can be performed responsive to the interaction between the instrument and the environmental structure being classified (at 1502) as a contact condition. In response to the interaction being classified as the non-contact condition, the estimating of the measure of force is not performed (e.g., omitted) and/or the estimated measure of force can be performed but the resulting force estimate can be deleted or discarded. Also, or alternatively, the measure of force can be estimated over a time interval during which contact is being made based on the tracked estimated spatial position for the instrument.

The measure of force further can be estimated at 1508 based on the three-dimensional normalized position for the portion of the instrument, such as determined at 1506. For example, the three-dimensional normalized position for the portion of the instrument includes a plurality of discrete normalized position values determined by the position estimation model over a time interval, and the estimated measure of force is determined by applying a force estimation model to plurality of discrete normalized position values to predict the measure of force, in which the force estimation model comprises a neural network trained on state information derived from the instrument and/or position measurements of the instrument with corresponding labeled images representative of an instrument interacting with an object.

In some examples, the position estimation model used at 1508 is further programmed to provide the three-dimensional normalized position for the portion of the instrument based on additional position data. The additional position data (e.g., data 1410) can be representative of a sensed position for the portion of the instrument and/or measured parameters associated with a joint space for the instrument.

Also, or as an alternative, the instrument can be a robotically controlled instrument and the environmental structure comprises biological tissue and/or other structures on or within a region of interest.

In some examples, at 1510, the method can include controlling sensory perceptible feedback for a user based on the estimated measure of force. For example, the sensory perceptible feedback can be provided to a user of the instrument. The method can further include scaling (e.g., by feedback generator 1426) the estimated measure of force and generating (e.g., by feedback generator 1426) a feedback signal based on the scaled and estimated measure of force. Sensory perceptible feedback can be provided based on the feedback signal. Also, or as an alternative, the sensory perceptible feedback includes one or more of audible feedback, visual feedback, and/or physical feedback. The method can be implemented to control one or more devices to provide one or more types of sensory perceptible feedback based on the estimated force.

In view of the foregoing, the systems and methods herein can provide a hybrid model- and learning-based approach to visual force estimation. Unlike traditional supervised learning methods, the approach does not require external sensor measurements for model training and parameter fitting. The contact detection and keypoint-based labeling can leverage human crowd-sourcing, which can have comparable accuracy to sensor-based labels. The accuracy of the systems and methods makes them highly applicable in tissue handling skill evaluations and for providing haptic feedback via sensory substitution.

The systems and methods described herein include an advantage of being quickly adaptable and scalable to novel scenarios (e.g., surgical, construction, manufacturing, handling hazardous materials, etc.). The developed learning-based normalized position estimator exhibits zero-shot transfer capability to new scenarios. Furthermore, its performance can be further improved via fine-tuning on end effector position measurements. The learning-based position estimator consequently enables contact-conditional force estimation for video-only surgical data streams. Accordingly, the systems and methods described herein are highly suitable for clinical settings, where data is often limited.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations can necessarily be present in each aspect provided herein.

As used in this application, “or” is intended to mean an inclusive “or” rather than an exclusive “or”. Further, an inclusive “or” can include any combination thereof (e.g., A, B, or any combination thereof). In addition, “a” and “an” as used in this application are generally construed to mean “one or more” unless specified otherwise or clear from context to be directed to a singular form. Additionally, at least one of A and B or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It should be understood that various aspects disclosed herein can be combined in different combinations than the combinations specifically presented in the description and accompanying drawings. It should also be understood that, depending on the example, certain acts or events of any of the processes or methods described herein can be performed in a different sequence, can be added, merged, or left out altogether (e.g., all described acts or events are not necessary to conduct the techniques). In addition, while certain aspects of this disclosure are described as being performed by a single module or unit for purposes of clarity, it should be understood that the techniques of this disclosure can be performed by a combination of units or modules associated with, for example, a medical device.

In one or more examples, the described techniques can be implemented in hardware, software, firmware, or any combination thereof. If implemented in software, the functions can be stored as one or more instructions or code on a computer-readable medium and executed by a hardware-based processing unit. Computer-readable media can include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions can be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein can refer to any of the foregoing structure or any other physical structure suitable for implementation of the described techniques. Also, the techniques could be fully implemented in one or more circuits or logic elements.

A “processor”, as used herein, processes signals and performs general computing and arithmetic functions. Signals processed by the processor can include digital signals, data signals, computer instructions, processor instructions, messages, a bit, a bit stream, or other means that can be received, transmitted, or detected. Generally, the processor can be a variety of various processors including multiple single and multicore processors and co-processors and other multiple single and multicore processor and co-processor architectures. The processor can include various modules to execute various functions.

A “memory”, as used herein, can include volatile memory or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory can store an operating system that controls or allocates resources of a computing device.

A “disk” or “drive”, as used herein, can be a magnetic disk drive, a solid-state disk drive, a floppy disk drive, a tape drive, a Zip drive, a flash memory card, or a memory stick. Furthermore, the disk can be a CD-ROM (compact disk ROM), a CD recordable drive (CD-R drive), a CD rewritable drive (CD-RW drive), or a digital video ROM drive (DVD-ROM). The disk can store an operating system that controls or allocates resources of a computing device.

A “bus”, as used herein, refers to an interconnected architecture that is operably connected to other computer components inside a computer or between computers. The bus can transfer data between the computer components. The bus can be a memory bus, a memory controller, a peripheral bus, an external bus, a crossbar switch, or a local bus, among others.

A “database”, as used herein, can refer to a table, a set of tables, and a set of data stores (e.g., disks) or methods for accessing or manipulating those data stores.

An “operable connection”, or a connection by which entities are “operably connected”, is one in which signals, physical communications, or logical communications can be sent or received. An operable connection can include a wireless interface, a physical interface, a data interface, or an electrical interface.

A “computer communication”, as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, etc. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

It will be appreciated that various of the above-disclosed and other features and functions, or alternatives or varieties thereof, can be desirably combined into many other different systems or applications. Also, that various presently unforeseen or unanticipated alternatives, modifications, variations, or improvements therein can be subsequently made by those skilled in the art which are also intended to be encompassed by the following claims.

All references, publications, and patents cited in the present application are herein incorporated by reference in their entirety.

1. A method comprising:
estimating, by a processor, a spatial position of a portion of an instrument that is adapted to interact with an environmental structure to provide an estimated spatial position for the instrument, in which the spatial position is estimated based on image data that includes at least one image frame of the portion of the instrument and the environmental structure; and
responsive to detecting contact between the instrument and the environmental structure, estimating, by the processor, a measure of force between the instrument and the environmental structure based on the estimated spatial position for the instrument.

2. The method of claim 1, further comprising:
classifying, by the processor, an interaction between the instrument and the environmental structure as one of a contact condition or a non-contact condition based on an analysis of the at least one image frame, wherein estimating the measure of force is performed responsive to the interaction between the instrument and the environmental structure being classified as the contact condition.

3. The method of claim 2, further comprising:
tracking the estimated spatial position for the instrument over a time interval from when the contact condition is detected and while the contact condition is maintained, and
wherein estimating the measure of force comprises estimating the measure of force over the time interval based on the tracked estimated spatial position for the instrument.

4. The method of claim 2, wherein, responsive to the interaction between the instrument and the environmental structure being classified as the non-contact condition, (i) estimating the measure of force is not performed, and/or (ii) the estimated measure of force is deleted or discarded.

5. The method of claim 1, wherein estimating the spatial position further comprises:
identifying geometric features of the portion of the instrument based on the at least one image frame; and
determining locations of pixels or voxels for each of the identified geometric features in the at least one image frame,
wherein the estimated spatial position is determined based on the locations of the pixels or voxels for the identified geometric features.

6. The method of claim 1, wherein estimating the spatial position further comprises:
applying a keypoints model to the at least one image frame to extract a set of geometric points of the portion of the instrument, in which the set of geometric points represents a geometric relationship of the geometric points of the instrument;
determining pixel coordinates in the at least one image frame based on the extracted set of geometric points; and
applying a position estimation model to provide a three-dimensional normalized position for the portion of the instrument based on the pixel coordinates in the at least one image frame, wherein estimating the measure of force comprises estimating the measure of force based on the three-dimensional normalized position for the portion of the instrument.

7. The method of claim 6, wherein the three-dimensional normalized position for the portion of the instrument includes a plurality of discrete normalized position values determined by the position estimation model over a time interval, and estimating the measure of force comprises:
applying a force estimation model to plurality of discrete normalized position values to predict the measure of force, in which the force estimation model comprises a neural network trained on state information derived from the instrument and/or position measurements of the instrument with corresponding labeled images representative of an instrument interacting with an object.

8. The method of claim 6, wherein the position estimation model further is programmed to provide the three-dimensional normalized position for the portion of the instrument based on additional position data, in which the additional position data is representative of a sensed position for the portion of the instrument and/or measured parameters associated with a joint space for the instrument.

9. The method of claim 1, wherein the instrument is a robotically controlled instrument and the environmental structure comprises biological tissue and/or other structures on or within a region of interest.

10. The method of claim 1, further comprising controlling sensory perceptible feedback for a user of the instrument based on the estimated measure of force.

11. The method of claim 10, further comprising:
scaling the estimated measure of force; and
generating a feedback signal based on the scaled and estimated measure of force; and
providing the sensory perceptible feedback based on the feedback signal.

12. The method of claim 10, wherein the sensory perceptible feedback comprises at least one of audible feedback, visual feedback, and/or physical feedback.

13. A system, comprising:
one or more processors;
one or more non-transitory machine-readable media storing data and executable instructions, wherein the data comprises image data that includes at least one image frame of a portion of an instrument and an environmental structure with which the instrument is adapted to interact, and wherein the instructions, when executed by the processor, cause the processor to perform a method comprising:
classifying a contact condition between the portion of the instrument and the environmental structure based on the at least one image frame;
estimating a spatial position or displacement of the portion of the instrument to provide an estimated spatial position or displacement for the instrument, in which the estimated spatial position or displacement for the instrument is based on the image data; and
responsive to the classified contact condition between the instrument and the environmental structure, estimating a measure of force between the instrument and the environmental structure based on the estimated spatial position or displacement for the instrument.

14. The system of claim 13, wherein the instructions for estimating the spatial position or displacement further comprise:
identifying geometric features of the portion of the instrument based on the at least one image frame of the image data; and
determining locations of pixels or voxels for each of the identified geometric features in the at least one image frame,
wherein the estimated spatial position or displacement for the instrument is determined based on the locations of the pixels or voxels for the identified geometric features.

15. The system of claim 13, wherein the instructions are further programmed to:
track the estimated spatial position or displacement for the instrument over a time interval from when contact between the instrument and the environmental structure is detected and while the contact condition is maintained, and
wherein estimated the measure of force between the instrument and the environmental structure is determined over the time interval based on the tracked estimated spatial position or displacement for the instrument.

16. The system of claim 13, wherein the instructions for estimating the spatial position further comprises:
a keypoints model to which the at least one image frame applied to extract a set of geometric points of the portion of the instrument, the set of geometric points representing a geometric relationship of the geometric points of the instrument;
instructions to determine pixel coordinates in the at least one image frame based the extracted set of geometric points; and
a position estimation model, defining the instructions for estimating the spatial position or displacement, programmed to provide a three-dimensional normalized position or displacement for the portion of the instrument based on the pixel coordinates in the at least one image frame, wherein the estimated measure of force is computed based on the three-dimensional normalized position or displacement for the portion of the instrument.

17. The system of claim 16, wherein the three-dimensional normalized position or displacement for the portion of the instrument includes a plurality of discrete normalized position and/or displacement values determined by the position estimation model over a time interval during the contact condition, and
wherein the instructions for estimating the measure of force comprises a force estimation model to which the plurality of discrete normalized position and/or displacement values are applied to predict the estimated the measure of force between the instrument and the environmental structure, in which the force estimation model comprises a neural network trained on state information derived from the instrument and/or position measurements of the instrument with corresponding labelled images representative of an instrument interacting with an object.

18. The system of claim 13, wherein the instructions further comprise instructions to generate a sensory perceptible feedback for a user based on the estimated measure of force, in which the sensory perceptible feedback comprises at least one of audible feedback, visual feedback, and/or physical feedback.

19. The system of claim 18, further comprising:
the instrument, in which the instrument comprises a robotically controlled instrument and the environmental structure comprises biological tissue and/or other structures on or within a region of interest; and
a user interface device in communication with the robotically controlled instrument, the user interface device configured to provide the sensory perceptible feedback.

20. A system, comprising:
an imaging device configured to provide image data including a plurality of image frames, in which the image frames include a remotely control instrument and a deformable structure;
a computing apparatus including instructions stored in non-transitory memory, which are executable by a processor, wherein the instructions comprise:
a contact detection model that classifies a contact condition between a portion of the instrument and the deformable structure based on at least one image frame;
a keypoint identification model that generates keypoints data based on the at least one image frame, in which the keypoints data defines a geometric network of keypoints of the instrument and includes coordinates of pixels or voxels in the at least one image frame;
a position estimation model that generates a predicted position estimate representative of a spatial position or displacement of the portion of the instrument to, in which the estimated spatial position or displacement for the instrument is based on the keypoints data; and
a force estimation model that generates a predicted force estimate responsive to the classified contact condition between the instrument and the deformable structure, the predicted measure of force between the instrument and the environmental structure being determined based on the predicted position estimate.
